(19) United States
(12) Patent Application Publication
(10) Pub. No.: US 2025/0080174 A1
(43) Pub. Date: Mar. 6, 2025

(54) TECHNIQUES FOR PRECODING MATRIX INDICATOR REPORTING

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US)

(21) Appl. No.: 18/708,998

(22) PCT Filed: Jan. 27, 2022
(86) PCT No.: PCT/CN2022/074154

§ 371 Date: May 9, 2024

(51) Int. Cl. H04B 7/0456; H04B 7/06

(52) U.S. Cl. CPC H04B 7/0456; H04B 7/0626

(57) ABSTRACT

Methods, systems, and devices for wireless communication are described. A communication device may support precoding matrix indicator (PMI) reporting. For example, the communication device may receive first control signaling indicating a reporting configuration for a set of PMI parameters. The communication device may transmit second control signaling indicating a set of PMI parameters according to a first periodicity and based on the reporting configuration. The communication device may transmit third control signaling indicating a subset of PMI parameters of the set of PMI parameters according to a second periodicity and based on the reporting configuration.

### CROSS REFERENCE

The present Application is a 371 national phase filing of International PCT Application No. PCT/CN2022/074154 by LI et al., entitled “TECHNIQUES FOR PRECODING MATRIX INDICATOR REPORTING,” filed Jan. 27, 2022, which is assigned to the assignee hereof, and which is expressly incorporated by reference in its entirety herein.

### FIELD OF TECHNOLOGY

The following relates to wireless communication, including techniques for precoding matrix indicator (PMI) reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support techniques for precoding matrix indicator (PMI) reporting. A communication device may be configured with a reporting configuration for PMI parameters. For example, the communication device may receive a radio resource control (RRC) message, a medium access control-control element (MAC-CE), or downlink control information (DCI) carrying a reporting configuration for PMI parameters. The reporting configuration may indicate periodicities for PMI reporting. For example, the communication device may transmit a set of PMI parameters according to a first periodicity, and transmit a subset of PMI parameters according to a second periodicity. The subset of PMI parameters may include one or more parameter of the set of PMI parameters.

For example, the set of PMI parameters may include reference signal resources (such as, channel state information (CSI) reference signal (CSI-RS) resources) and reference signal antenna ports (such as, CSI-RS ports), while the subset of PMI parameters may include linear combinations of non-zero (NZ) power beam coefficients associated with one or both of the reference signal resources or the reference signal ports. In some examples, the first periodicity may be greater than the second periodicity. In some examples, the first periodicity and the second periodicity may correspond to an offset in a time domain between the first periodicity and the second periodicity. By implementing the different periodicities for PMI reporting, the communication device may promote high reliability and low latency wireless communication.

A method for wireless communication at a UE is described. The method may include receiving first control signaling indicating a reporting configuration for a set of multiple PMI parameters, transmitting second control signaling indicating a set of PMI parameters according to a first periodicity and based on the reporting configuration, and transmitting third control signaling indicating a subset of PMI parameters of the set of PMI parameters according to a second periodicity and based on the reporting configuration.

An apparatus for wireless communication at a UE is described. The apparatus may include a processor, memory; a transceiver; and at least one processor of a UE, the at least one processor coupled with the memory and the transceiver, and the at least one processor configured to cause the apparatus to receive first control signaling indicating a reporting configuration for a set of multiple PMI parameters, transmit second control signaling indicating a set of PMI parameters according to a first periodicity and based on the reporting configuration, and transmit third control signaling indicating a subset of PMI parameters of the set of PMI parameters according to a second periodicity and based on the reporting configuration.

Another apparatus for wireless communication at a UE is described. The apparatus may include means for receiving first control signaling indicating a reporting configuration for a set of multiple PMI parameters, means for transmitting second control signaling indicating a set of PMI parameters according to a first periodicity and based on the reporting configuration, and means for transmitting third control signaling indicating a subset of PMI parameters of the set of PMI parameters according to a second periodicity and based on the reporting configuration.

A non-transitory computer-readable medium storing code for wireless communication at a UE is described. The code may include instructions executable by a processor to receive first control signaling indicating a reporting configuration for a set of multiple PMI parameters, transmit second control signaling indicating a set of PMI parameters according to a first periodicity and based on the reporting configuration, and transmit third control signaling indicating a subset of PMI parameters of the set of PMI parameters according to a second periodicity and based on the reporting configuration.

In some examples of the method, apparatuses, and non-transitory computer-readable medium described herein, receiving the first control signaling may include operations, features, means, or instructions for receiving a single CSI reporting configuration for the set of multiple PMI parameters, the single CSI reporting configuration indicating one or both of the first periodicity or the second periodicity.

Some examples of the method, apparatuses, and non-transitory computer-readable medium described herein may further include operations, features, means, or instructions for transmitting jointly the second control signaling and the third control signaling based on the single CSI reporting configuration, the second control signaling indicating a first CSI report and the third control signaling indicating a second CSI report, the first CSI report being adjacent to the second CSI report.

Some examples of the method, apparatuses, and non-transitory computer-readable medium described herein may further include operations, features, means, or instructions for determining a resource allocation based on the single CSI reporting configuration, the resource allocation including a first set of resources for a first type of CSI report and a second set of resource for a second type of CSI report and where transmitting one or both of the second control signaling or the third control signaling may be based on the resource allocation.

In some examples of the method, apparatuses, and non-transitory computer-readable medium described herein, receiving the first control signaling may include operations, features, means, or instructions for receiving a first CSI reporting configuration for the set of multiple PMI parameters, receiving a second CSI reporting configuration for the subset of PMI parameters of the set of PMI parameters, and where one or both of the first CSI reporting configuration or the second CSI reporting configuration indicate one or both of the first periodicity or the second periodicity.

Some examples of the method, apparatuses, and non-transitory computer-readable medium described herein may further include operations, features, means, or instructions for determining a resource allocation based on the second CSI reporting configuration, the resource allocation including a first set of resources for a first type of CSI report and a second set of resource for a second type of CSI report and where transmitting one or both of the second control signaling or the third control signaling may be based on the resource allocation.

In some examples of the method, apparatuses, and non-transitory computer-readable medium described herein, the set of PMI parameters includes one or both of a reference signal resource parameter or a reference signal port parameter and the subset of PMI parameters of the set of PMI parameters includes a linear combination of NZ coefficients associated with the set of PMI parameters.

In some examples of the method, apparatuses, and non-transitory computer-readable medium described herein, the subset of PMI parameters includes one or more of a channel quality indicator, a layer indicator, a rank indicator, a total number of NZ coefficients, a strongest coefficient indicator, a coefficient selection for different multiple-input multiple-output layers, or a quantized NZ coefficient.

Some examples of the method, apparatuses, and non-transitory computer-readable medium described herein may further include operations, features, means, or instructions for determining a condition to trigger reporting of one or both of the set of PMI parameters or the subset of PMI parameters and transmitting, based on the condition, an indication for reporting one or both of the set of PMI parameters or the subset of PMI parameters.

In some examples of the method, apparatuses, and non-transitory computer-readable medium described herein, the indication includes one or more bits in a first part of a CSI report.

Some examples of the method, apparatuses, and non-transitory computer-readable medium described herein may further include operations, features, means, or instructions for transmitting the indication may be based on the first control signaling.

Some examples of the method, apparatuses, and non-transitory computer-readable medium described herein may further include operations, features, means, or instructions for transmitting the second control signaling indicating the set of PMI parameters of the set of multiple PMI parameters according to the first periodicity may be further based on the condition.

Some examples of the method, apparatuses, and non-transitory computer-readable medium described herein may further include operations, features, means, or instructions for determining that the set of PMI parameters may be less than the set of multiple PMI parameters and where transmitting the second control signaling may be further based on determining that the set of PMI parameters may be less than the set of multiple PMI parameters.

Some examples of the method, apparatuses, and non-transitory computer-readable medium described herein may further include operations, features, means, or instructions for determining a sequence of PMI reporting based on a condition and where transmitting one or both of the second control signaling or the third control signaling may be further based on the sequence of PMI reporting.

In some examples of the method, apparatuses, and non-transitory computer-readable medium described herein, one or both of the set of PMI parameters or the subset of PMI parameters may be associated with the condition.

In some examples of the method, apparatuses, and non-transitory computer-readable medium described herein, a priority associated with one or both of the second control signaling or the third control signaling may be further based on the condition; or the priority associated with one or both of the second control signaling or the third control signaling may be further based on the condition and at least one PMI parameter of the set of multiple PMI parameters satisfying a threshold.

Some examples of the method, apparatuses, and non-transitory computer-readable medium described herein may further include operations, features, means, or instructions for determining one or both of the first periodicity or the second periodicity based on a codebook and where transmitting one or both of the second control signaling or the third control signaling may be further based on the codebook.

Some examples of the method, apparatuses, and non-transitory computer-readable medium described herein may further include operations, features, means, or instructions for determining a first set of CPU resources associated with the set of PMI parameters of the set of multiple PMI parameters and a second set of CPU resources associated with the subset of PMI parameters of the set of PMI parameters, the second set of CPU resources may be less than the first set of CPU resources and where transmitting one or both of the second control signaling or the third control signaling may be further based on the first set of CPU resources and the second set of CPU resources.

Some examples of the method, apparatuses, and non-transitory computer-readable medium described herein may further include operations, features, means, or instructions for determining a differential between the set of PMI parameters and the subset of PMI parameters and where transmitting one or both of the second control signaling or the third control signaling may be further based on the differential.

In some examples of the method, apparatuses, and non-transitory computer-readable medium described herein, one or both of the second control signaling or the third control signaling includes one or both of non-differential coefficients or differential coefficients combinations of the set of multiple PMI parameters.

Some examples of the method, apparatuses, and non-transitory computer-readable medium described herein may further include operations, features, means, or instructions for determining that the differential coefficients includes one or both of a differential amplitude quantization or a differential phase quantization and where transmitting one or both of the second control signaling or the third control signaling may be further based on determining that the differential coefficients includes one or both of the differential amplitude quantization or the differential phase quantization. Alternatively, some examples of the method, apparatuses, and non-transitory computer-readable medium described herein may further include operations, features, means, or instructions for determining that the differential coefficients includes one or both of a number of bits quantizing a differential amplitude change or a number of bits quantizing a differential phase change and where transmitting one or both of the second control signaling or the third control signaling may be further based on determining that the differential coefficients includes one or both of the number of bits quantizing the differential amplitude change or the number of bits quantizing the differential phase change.

In some examples of the method, apparatuses, and non-transitory computer-readable medium described herein, the second control signaling includes less bits for quantization than the third control signaling.

Some examples of the method, apparatuses, and non-transitory computer-readable medium described herein may further include operations, features, means, or instructions for determining a shift to a periodicity for PMI reporting and where transmitting one or both of the second control signaling or the third control signaling may be further based on the shift to the periodicity for PMI reporting.

In some examples of the method, apparatuses, and non-transitory computer-readable medium described herein, the first periodicity being greater than the second periodicity and the first periodicity and the second periodicity correspond to an offset in a time domain between the first periodicity and the second periodicity.

A method for wireless communication at a base station is described. The method may include transmitting first control signaling indicating a reporting configuration for a set of multiple PMI parameters, receiving second control signaling indicating a set of PMI parameters according to a first periodicity and based on the reporting configuration, and receiving third control signaling indicating a subset of PMI parameters of the set of PMI parameters according to a second periodicity and based on the reporting configuration.

An apparatus for wireless communication at a base station is described. The apparatus may include a processor, memory; a transceiver; and at least one processor of a base station, the at least one processor coupled with the memory and the transceiver, and the at least one processor configured to cause the apparatus to transmit first control signaling indicating a reporting configuration for a set of multiple PMI parameters, receive second control signaling indicating a set of PMI parameters according to a first periodicity and based on the reporting configuration, and receive third control signaling indicating a subset of PMI parameters of the set of PMI parameters according to a second periodicity and based on the reporting configuration.

Another apparatus for wireless communication at a base station is described. The apparatus may include means for transmitting first control signaling indicating a reporting configuration for a set of multiple PMI parameters, means for receiving second control signaling indicating a set of PMI parameters according to a first periodicity and based on the reporting configuration, and means for receiving third control signaling indicating a subset of PMI parameters of the set of PMI parameters according to a second periodicity and based on the reporting configuration.

A non-transitory computer-readable medium storing code for wireless communication at a base station is described. The code may include instructions executable by a processor to transmit first control signaling indicating a reporting configuration for a set of multiple PMI parameters, receive second control signaling indicating a set of PMI parameters according to a first periodicity and based on the reporting configuration, and receive third control signaling indicating a subset of PMI parameters of the set of PMI parameters according to a second periodicity and based on the reporting configuration.

In some examples of the method, apparatuses, and non-transitory computer-readable medium described herein, the set of PMI parameters includes one or both of a reference signal resource parameter or a reference signal port parameter and the subset of PMI parameters of the set of PMI parameters includes a linear combination of NZ coefficients associated with the set of PMI parameters.

### BRIEF DESCRIPTION OF THE DRAWINGS

FIGS. 1 and 2 illustrate examples of wireless communications systems that support techniques for PMI reporting in accordance with aspects of the present disclosure.

FIG. 3 illustrates an example of a process flow that supports techniques for PMI reporting in accordance with aspects of the present disclosure.

FIGS. 4 and 5 show block diagrams of devices that support techniques for PMI reporting in accordance with aspects of the present disclosure.

FIG. 6 shows a block diagram of a communications manager that supports techniques for PMI reporting in accordance with aspects of the present disclosure.

FIG. 7 shows a diagram of a system including a device that supports techniques for PMI reporting in accordance with aspects of the present disclosure.

FIGS. 8 and 9 show block diagrams of devices that support techniques for PMI reporting in accordance with aspects of the present disclosure.

FIG. 10 shows a block diagram of a communications manager that supports techniques for PMI reporting in accordance with aspects of the present disclosure.

FIG. 11 shows a diagram of a system including a device that supports techniques for PMI reporting in accordance with aspects of the present disclosure.

FIGS. 12 and 13 show flowcharts illustrating methods that support techniques for PMI reporting in accordance with aspects of the present disclosure.

### DETAILED DESCRIPTION

A wireless communications system may include communication devices, such as a UE or a base station (e.g., an eNodeB (eNB), a next-generation NodeB or a giga-NodeB, any of which may be referred to as a gNB, or some other base station), that may support multiple radio access technologies. Examples of radio access technologies include 4G systems, such as LTE systems, and 5G systems, which may be referred to as NR systems. A communication device may be configured with multiple antenna panels to support beamformed communications with multiple other communication devices, for example, in a multiple-input multiple output (MIMO) deployment. Additionally, the communication device may support channel measurement and reporting on one or more of the antenna panels to decrease latency or increase reliability of beamformed communications. For example, the communication device may perform channel measurement and reporting, such as channel state information (CSI) measurement and reporting.

The CSI reporting may include one or more parameters, which may include precoding matrix indicator (PMI) parameters indicating beam weights (also referred to as beam coefficients) for the beamformed communication. In some cases, the communication device may experience high overhead signaling due to frequent channel measurement and reporting related to beamformed communications. It may be desirable to reduce overhead signaling related to CSI measurement and reporting. Various aspects of the present disclosure relate to the communication device being configured with a reporting configuration for PMI parameters. For example, the communication device may receive a radio resource control (RRC) message, a medium access control-control element (MAC-CE), or downlink control information (DCI) carrying a reporting configuration for PMI parameters.

The reporting configuration may indicate periodicities for PMI reporting. For example, the communication device may transmit a set of PMI parameters according to a first periodicity, and transmit a subset of PMI parameters according to a second periodicity. Periodically transmitting a subset of PMI parameters instead of the set of PMI parameters may decrease overhead of control signaling. The subset of PMI parameters may include one or more parameter of the set of PMI parameters. For example, the set of PMI parameters may include reference signal resources (such as, CSI reference signal (CSI-RS) resources) and reference signal antenna ports (such as, CSI-RS ports), while the subset of PMI parameters may include linear combinations of NZ power beam coefficients associated with one or both of the reference signal resources or the reference signal ports. In some examples, the first periodicity may be greater than the second periodicity. In some examples, the first periodicity and the second periodicity may correspond to an offset in a time domain between the first periodicity and the second periodicity.

By implementing the different periodicities for PMI reporting, the communication device may promote high reliability and low latency wireless communication. The communication device may also manage resource utilization by supporting different periodicities for PMI reporting. Additionally, the communication device may reduce power consumption by managing different periodicities for PMI reporting.

Aspects of the disclosure are initially described in the context of wireless communications systems. Aspects of the disclosure are further illustrated by and described with reference to apparatus diagrams, system diagrams, and flowcharts that relate to techniques for PMI reporting.

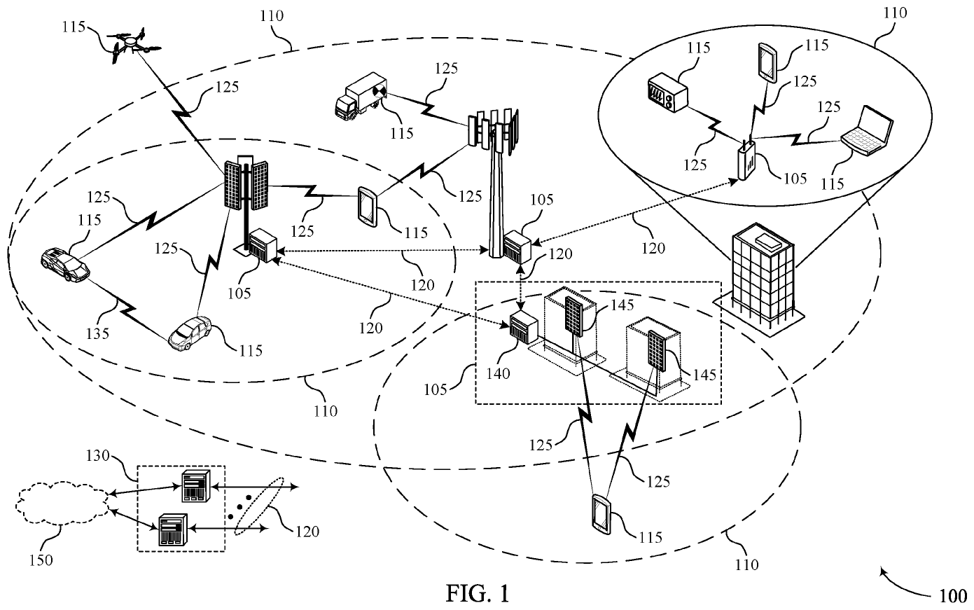

FIG. 1 illustrates an example of a wireless communications system 100 that supports techniques for PMI reporting in accordance with aspects of the present disclosure. The wireless communications system 100 may include one or more base stations 105, one or more UEs 115, and a core network 130. In some examples, the wireless communications system 100 may be an LTE network, an LTE-A network, an LTE-A Pro network, or an NR network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or another interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links. One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples. The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

A carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology). The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers. In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a PMI or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may support CSI reporting, which may include reporting of a PMI. Based on the PMI, one or both of a base station 105 or a UE 115 may determine how data streams (e.g., layers) are mapped to antennas of one or both of the base station 105 or the UE 115. In some cases, a UE 115 may be configured with different PMI types, such as a first PMI type (also referred to as PMI Type-1) or a second PMI type (also referred to as PMI Type-2). A UE 115 may sample DFT beams in a frequency domain (FD). In some cases, the UE 115 may oversample DFT beams in the FD. The UE 115 may support linear combinations of oversampled DFT beams in the FD. In some cases, a PMI Type-2 reporting may support reporting for linear combinations of oversampled DFT beams in the FD. However, the UE 115 may experience a high overheard for PMI reporting due to PMI feedback.

In some cases, by enabling the UE 115 to support PMI Type-2 reporting, the UE 115 may reduce Type-2 CSI overhead while preserving CSI performance. For PMI Type-2 reporting, a UE 115 may calculate a precoder on each radio frequency band. For example, the UE 115 may calculate a precoder on each radio frequency subband as a linear combination of spatial beams. The UE 115 may aggregate coefficients on each radio frequency band. For example, the UE 115 may aggregate coefficients on each radio frequency subband. The UE 115 may perform FD compression of coefficients via DFT techniques. The UE 115 may support transfer domain (e.g., delay domain) compression of a FD linear combination of coefficients via DFT bases. The coefficients after compression may be spares in the delay domain. The UE 115 may support reporting of spatial beams, delay domain coefficients, and the compression DFT bases. In some cases, one or both of a base station 105 or a UE 115 may support machine learning-based CSI feedback reporting. A UE 115 may estimate a channel (e.g., or a CSI-RS) and determine CSI based on the estimated channel. The UE 115 may compress the CSI, which may reduce overhead signaling, and transmit the compressed CSI to the base station 105. The base station 105 may decompress and reconstruct the CSI associated with the estimated channel based on the decompressed CSI.

A UE 115 may be configured with multiple antenna panels to support beamformed communications with multiple other communication devices. Additionally, the UE 115 may support channel measurement and reporting on one or more of the antenna panels to decrease latency or increase reliability of beamformed communications. For example, the UE 115 may perform channel measurement and reporting, such as CSI measurement and reporting. In some cases, the CSI reporting may include one or more parameters, which may include PMI parameters indicating beam weights for the beamformed communication. In some cases, the UE 115 may experience high overhead signaling due to frequent channel measurement and reporting related to beamformed communications. In periodical CSI-reports, spatial and FD compression bases may be updated in each CSI-report even though they may not change frequently comparing to quantized coefficients. Additionally, quantized coefficients may change incrementally instead of frequently.

Various aspects of the present disclosure relate to the UE 115 being configured with an enhanced CSI reporting framework (e.g., including PMI reporting framework) to support more frequent compression coefficient updates and less frequent spatial and FD-compression bases updates. For example, the UE 115 may receive an RRC message, a MAC-CE, or DCI carrying a reporting configuration for PMI parameters. The reporting configuration may indicate periodicities for PMI reporting. For example, the UE 115 may transmit a set of PMI parameters according to a first periodicity, and transmit a subset of PMI parameters according to a second periodicity. The subset of PMI parameters may include one or more parameter of the set of PMI parameters. In some examples, the first periodicity may be greater than the second periodicity. In some examples, the first periodicity and the second periodicity may correspond to an offset in a time domain between the first periodicity and the second periodicity.

By implementing the different periodicities for PMI reporting, the UE 115 may promote high reliability and low latency wireless communication. The UE 115 may also manage resource utilization by supporting different periodicities for PMI reporting. Additionally, the UE 115 may reduce power consumption by managing different periodicities for PMI reporting.

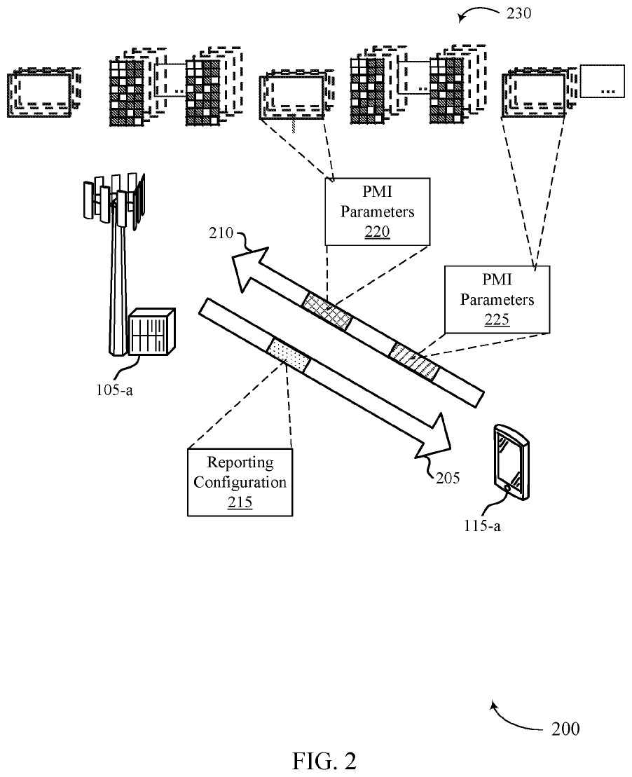

FIG. 2 illustrates an example of a wireless communications system 200 that supports techniques for PMI reporting in accordance with aspects of the present disclosure. The wireless communications system 200 may implement or be implemented by one or more aspects of the wireless communications system 100. For example, the wireless communications system 200 may include a base station 105-a and a UE 115-a, which may be examples of a base station 105 and a UE 115 as described with reference to FIG. 1. The base station 105-a and the UE 115-a may communicate over a communication link 205 and a communication link 210, which may be examples of communication links 125 as described with reference to FIG. 1. The wireless communications system 200 may support improvements to power consumption and, in some examples, may promote high reliability and low latency wireless communications, among other benefits.

One or both of the base station 105-a or the UE 115-a may be configured with multiple antennas. The antennas of one or both of the base station 105-a or the UE 115-a may be located within one or more antenna arrays or antenna panels, which may support transmit or receive wireless communication. The base station 105-a may have one or more antenna arrays with a number of rows and columns of antenna ports that the base station 105-a may use to support wireless communication with the UE 115-a. Likewise, the UE 115-a may have one or more antenna arrays with a number of rows and columns of antenna ports that the UE 115-a may use to support wireless communication with the base station 105-a. One or both of the base station 105-a or the UE 115-a may thus be configured to support wireless communication using one or multiple antennas. In some examples, one or both of the base station 105-a or the UE 115-a may be configured to support operations to manage or improve wireless communication between the base station 105-a and the UE 115-a.

In the example of FIG. 2, the UE 115-a may support PMI operations, such as PMI reporting to promote high reliability and low latency wireless communications with the base station 105-a. In some examples, the base station 105-a may transmit, and the UE 115-a may receive, a reporting configuration 215. In some examples, the base station 105-a may transmit, and the UE 115-a may receive, the reporting configuration 215 via an RRC message, or a MAC-CE, or a DCI, or any combination thereof. The PMI reporting may include one or more PMI parameters. Examples of PMI parameters include a reference signal resource parameter or a reference signal port parameter, for example, spatial domain (SD) bases, CSI antenna ports, CSI-RS resources, synchronization signal block (SSB) resources, joint CSI-RS resources and CSI antenna ports, FD compression bases, as well as linear combination of NZ coefficients associated with the SD and FD bases.

In some examples, based on the reporting configuration 215, the UE 115-a may transmit, and the base station 105-a may receive, PMI parameters 220 (e.g., a set of PMI parameters or a number of PMI parameters) according to a first periodicity. In some other examples, based on the reporting configuration 215, the UE 115-a may transmit, and the base station 105-a may receive, PMI parameters 225 according to a second periodicity. For example, the UE 115-a may report the PMI parameters 220 (e.g., a first number of PMI parameters) according to a first periodicity in a time domain, and the PMI parameters 225 (e.g., a second number of PMI parameters) according to a second periodicity in the time domain. In some examples, the first periodicity may be greater than the second periodicity. In some cases, the PMI parameters 225 may be a subset of the PMI parameters 220.

The UE 115-a may report at least one parameter of the PMI parameters 225 between a reporting of at least two parameters of the PMI parameters 225. In some examples, the PMI parameters 225 reported between at least two adjacent parameters reporting of the PMI parameters 220 may be associated with a recent PMI parameter of the PMI parameters 220. In other words, the reported second number of PMI parameters between two adjacent first number of PMI parameters may be associated with a recent reported first number of PMI parameters. In some examples, the PMI parameters 225 (e.g., the second number of PMI parameters) between two adjacent PMI parameters 220 (e.g., two adjacent first number of PMI parameters) may be differentially reported by the UE 115-a. In some examples, the UE 115-a may report non-differentially reported PMI parameters 225 (e.g., the second PMI parameter set) within the latest PMI parameters 220 (e.g., latest first PMI parameter set report). Alternatively, the UE 115-a may report the latest PMI parameters 220 (e.g., latest first PMI parameter set report) or the second PMI parameters (e.g., may be the non-differential ones or the differential ones). As described herein, a differential report may be defined as a numerical differential (e.g., differential coefficients report) or additional updates (e.g., e.g., suppl or remove bases on top of recently reported ones), or both.

In some examples, the PMI parameters 220 may include reference signal resource parameter or a reference signal port parameter, such as, SD bases, CSI antenna ports, CSI-RS resources, SSB resources, joint CSI-RS resources and CSI antenna ports, FD compression bases. In some examples, the PMI parameters 225 may include linear combination of NZ coefficients associated with the PMI parameters 220. The linear combination NZ coefficients reported within a same first PMI reporting instance as the FD-bases, SD-bases, resource election, antenna port selection, resource and antenna port selection, or any combination thereof, may be associated with such FD-bases, SD-bases, resource election, antenna port selection, resource and antenna port select. Additionally or alternatively, the linear combination NZ coefficients 230 reported after the first PMI reporting instance but before the second PMI reporting instance, which also include the FD-bases, SD-bases, resource election, antenna port selection, resource and antenna port selection, or any combination thereof, may be associated with the FD-bases, SD-bases, resource election, antenna port selection, resource and antenna port selection, or any combination thereof, of the first PMI reporting instance.

The UE 115 may report non-differential and differential linear combination of NZ coefficients associated with at least the SD-bases, CSI antenna ports, CSI-RS resource, SSB resources, or joint CSI-RS resources and CSI-RS antenna ports, or FD compression bases. In some examples, the reporting periodicity of the FD-bases, SD-bases, resource election, antenna port selection, resource and antenna port selection, or any combination thereof, may be greater than the reporting periodicity of the linear combination coefficients. In some examples, the differential NZ coefficients only reports may be conveyed between two adjacent full PMI reports, where the full PMI reports include both the FD-bases, SD-bases, resource election, antenna port selection, resource and antenna port selection, and non-differential NZ coefficients.

The differential NZ coefficients may be referred to at least non-differential NZ coefficients and the FD-bases, SD-bases, resource election, antenna port selection, resource and antenna port selection in a latest full PMI report. In other words, differentially referred to the latest full PMI. Alternatively, the differential NZ coefficients may be referred to at least as latest reported NZ coefficients (e.g., can be either the non-differential ones or the differential ones) and latest reported FD-bases, SD-bases, resource election, antenna port selection, resource and antenna port selection. In other words, differentially referred to the latest NZ coefficients (either differential or non-differential ones), and the latest reported other components.

In some examples, the UE 115-a may support one or more CSI parameters in a NZ coefficient only report. At least one of the following parameters can may be included in a NZ coefficients only reports, and may be included in the same CSI-Part1 or CSI-Part2 as in the full PMI report. In some examples, the one or more CSI parameters may include a CQI, an LI, or an RI. In some cases, the reported RI may not exceed the RI reported together with the latest full PMI report. Additionally or alternatively, the RI and the LI might not be presented and are supposed to be the same as in the full PMI report. In some other examples, the one or more CSI parameters may include a total number of NZ coefficients. The UE 115-a may identify the same or different thresholds (e.g., upper bounds) for the total number of NZ coefficients comparing to the ones used in the full PMI report, based on the reporting configuration 215 (e.g., a CSI-ReportConfig). In other examples, the one or more CSI parameters may include a strongest coefficient indication, a coefficient selection for different layers, or quantized NZ coefficients, or any combination thereof. For example, NZ coefficients may be grouped or binned by quantizing the NZ coefficients. That is, the UE 115-a may compress NZ coefficients into a finite range of discreet values for PMI reporting. The UE 115-a may identify the same or different number of quantization bits for the quantized NZ coefficients comparing to the ones in the full PMI report, based on the reporting configuration 215 (e.g., a CSI-ReportConfig).

The base station 105-a may transmit, and the UE 115-a may receive, a single CSI reporting configuration (e.g., a CSI-ReportConfig) for one or both of the PMI parameters 220 or the PMI parameters 225. The single CSI reporting configuration may indicate one or both of the first periodicity or the second periodicity. As such, the unequal periodicity reporting for the PMI parameters 220 and the PMI parameters 225 may be configured with a single persistent or semi-persistent CSI reporting configuration (e.g., a CSI-ReportConfig). The single CSI reporting configuration (e.g., a CSI-ReportConfig) may indicate at least two periodicities, where the first periodicity may be associated with the PMI parameters 220 (e.g., joint FD and SD bases and NZ coefficients report), and the second periodicity may be associated with the PMI parameters 225 (e.g., NZ coefficients report). In some cases, a PMI parameter 225 may be inserted between two adjacent joint PMI parameters 220 (e.g., FD and SD bases and NZ coefficients report). For example, the PMI parameters 220 may include a first parameter and a second parameter, a first PMI parameter associated with the PMI parameters 225 may be reported between the reporting of the first parameter and the second parameter associated with the PMI parameters 220. The single CSI reporting configuration (e.g., a CSI-ReportConfig) may include at least two sets of uplink resource allocations (e.g., physical uplink control channel (PUCCH), physical uplink shared channel (PUSCH)) for respective types of reports.

Alternatively, the base station 105-a may transmit, and the UE 115-a may receive, multiple CSI reporting configuration (e.g., a CSI-ReportConfigs), each respective CSI reporting configuration corresponding to the PMI parameters 220 or the PMI parameters 225. For example, the unequal periodicity reporting for the PMI parameters 220 and the PMI parameters 225 may be configured using at least two persistent or semi-persistent CSI reporting configuration (e.g., a CSI-ReportConfig). The first CSI reporting configuration may be associated with the PMI parameters 220 (e.g., full PMI report including both the FD and SD bases and the NZ coefficients), while the second CSI reporting configuration may be associated with the PMI parameters 225 (e.g., only the NZ coefficients). The periodicity and resource allocation may only apply to the intervals between two CSI reports identified from the first CSI reporting configuration.

The UE 115-a may determine a condition (e.g., a full reporting enabled or disabled, which may be referred to as a panic button for the UE to enable reporting of the full set of PMI parameters and disable reporting of subsets of PMI parameters) to trigger reporting of one or both of the PMI parameters 220 or the PMI parameters 225. In some examples, the UE 115-a may determine a condition to fallback to a full PMI report. In some cases, during the second parameter set reporting (e.g., the NZ coefficients only report) instances, the UE 115-a may report whether the reported PMI includes only the PMI parameters 225 (e.g., NZ coefficients), or includes the PMI parameters 220 (e.g., full PMI including both the SD and FD bases, and the associated NZ coefficients). The UE 115-a may transmit an indication for reporting one or both of the PMI parameters 220 or the PMI parameters 225. The indication may be a single bit in CSI-Part1. Alternatively, the indication may be predefined, or the base station 105-a may configure the UE 115-a with invalid bit-points of the PMI parameters 225 (e.g., NZ-coefficients).

In some examples, based on the determination of the condition, the reported PMI parameters 220 (e.g., full PMI) may be based on the configuration for the PMI parameters 225 (e.g., full PMI) with longer periodicity. In some other examples, based on the determination of the condition, the UE 115-a may identify a reduced number of FD bases, or SD bases, or total number of NZ coefficients when reporting the PMI parameters 220 (e.g., full PMI) comparing to the configuration for the PMI parameters 220 (e.g., full PMI) with longer periodicity, wherein the reduced number may be based on further configurations by the base station 105-a and associated with the configuration for the PMI parameters 220 (e.g., full PMI) report or the PMI parameters 225 (e.g., NZ coefficients only) report.

In some other examples, the UE 115-a may determine sequential PMI reports based on determining that the current PMI parameters 220 (e.g., full PMI) report does not satisfy the condition (e.g., full reporting is enabled and subset reporting is disabled) as a normal PMI parameters 220 (e.g., full PMI) report, and resume the unequal periodicity reporting by reporting the PMI parameters 225 (e.g., NZ coefficients only PMI) from the following report instance. In some examples, the UE 115-a may identify an updated uplink resource allocation (e.g., based on a configuration) implicitly for sequential reports. In other examples, the UE 115-a may determine sequential PMI reports based on reporting periodicity in the following instance as usual despite the condition (e.g., full reporting is enabled and subset reporting is disabled). In some examples, the UE 115 may fallback to the PMI parameters 220 (e.g., full PMI report) for all sequential reports, and identify updated uplink resource allocation implicitly for sequential reports. In some cases, the PMI parameters 225 (e.g., NZ coefficients in the NZ coefficients only PMI) reports are associated without the satisfying the condition (e.g., full reporting is enabled and subset reporting is disabled). In some other cases, a CSI report associated with the condition not satisfied (e.g., subset reporting is enabled) may have a higher priority compared to another CSI report associated with the condition satisfied (e.g., full reporting is enabled and subset reporting is disabled). The UE 115-a may be allowed to report a very low RI (e.g., RI=1) when the condition is satisfied (e.g., full reporting is enabled and subset reporting is disabled).

The UE 115-a may determine one or both of the first periodicity associated with the PMI parameters 220 or the second periodicity associated with the PMI parameters 225 based a codebook. In other words, the unequal periodicity reporting can be based on a codebook. Examples of codebooks include eType2 FD compression codebook, a CSI-RS port selection codebook in conjunction with FD compression linear combination, a CSI-RS/SSB resource selection codebook in conjunction with FD compression linear combination, or a joint CSI-RS resource and CSI-RS port selection codebook in conjunction with FD compression linear combination. In some examples, the PMI parameters 220 and the PMI parameters 225 maybe associated with unequal CPU resources. For occupied number of CPUs may be counted with a smaller number for symbols associated with calculating the PMI parameters 225 (e.g., NZ coefficients only) CSI-reports, comparing to the occupied number of CPUs associated with calculating CSI-reports for the PMI parameters 220 (e.g., full PMI) report.

One or both of the base station 105-a or the UE 115-a may support quantization resolutions of differential reports. In some examples, differentially reported NZ coefficients may include differential amplitude quantization referred to the associated latest coefficients. In some other examples, differentially reported NZ coefficients may include differential amplitude quantization referred to as differential phase quantization referred to the associated latest coefficients. The number of bits to quantize the differential or the non-differential NZ coefficients reports, and the differential range and step-size can be further based on the reporting configuration 215, or dynamic updates (e.g., MAC-CE or DCI).

In some examples, one or both of the base station 105-a or the UE 115-a may support quantization resolution of the differential reported NZ coefficients. In some examples, the differentially reported NZ coefficients may include a number of bits quantizing the differential amplitude change and may be less than the number of bits quantizing the non-differential amplitude associated with the non-differential NZ coefficient report. In some other examples, the differentially reported NZ coefficients may include a number of bits quantizing the differential phase change may be less than the number of bits quantizing the non-differential phase associated with the non-differential NZ coefficient report. One or both of the base station 105-a or the UE 115-a may support multi-stage differential reporting. For example, there may be multi-stage differential PMI reports, such that a first stage may include less number of bits to quantize the differential amplitude or phase, or both, comparing to a second stage, and the first stage reports may be earlier or later than the second stage reports.

One or both of the base station 105-a or the UE 115-a may support fallback to a non-differential NZ coefficient report. For example, at the PMI parameters (e.g., differential NZ coefficients only) report instance, the UE 115-a may report whether the reported PMI includes only the PMI parameters 220 (e.g., differentially quantized NZ coefficients), or includes the PMI parameters 225 (e.g., non-differentially quantized NZ coefficients and additional components). This can be further based on a single bit indication in a CSI-Part 1 or configured by the base station 105-a via invalid bit-points of the differentially reported NZ coefficients.

In some examples, one or both of the base station 105-a or the UE 115-a may support a resolution of the quantization. The number of bits per coefficient for the non-differentially reported NZ coefficients when a condition is satisfied (e.g., full reporting is enabled and subset reporting is disabled), can be further based on at least one of the followings: the same as the non-differentially reported NZ coefficients in the full PMI reports, or separately predefined or via a configuration (e.g., in the enhanced CSI-ReportConfig) by the base station 105-a. In some other examples, one or both of the base station 105-a or the UE 115-a may support CSI reporting with the condition satisfied (e.g., full reporting is enabled and subset reporting is disabled). If the UE 115-a switched to fallback, the UE 115-a behaviors on the reported information include at least one of the followings: a new RI smaller than the RI reported in the latest PMI parameters 220 (e.g., full PMI) is expected to be reported in the CSI report, a new (e.g., greater or smaller) upper bound on the total number of NZ coefficients to be reported can be identified, or completely fallback to PMI parameters 220 (e.g., full PMI) reporting.

In some examples, CSI reporting when a condition is satisfied (e.g., full reporting is enabled and subset reporting is disabled) may be based on the UE 115-a determining the current PMI parameters 220 (e.g., full PMI) report as a normal PMI parameters 220 (e.g., full PMI) report with non-differentially reported PMI parameters 225 (e.g., NZ coefficients), and resume the remaining PMI parameters 225 (e.g., differentially reported NZ coefficients) reporting from the following report instance, wherein the differential is referred to the PMI report. In some cases, the original periodicity may not be impacted (e.g., full-diff-diff-diff-diff-full-“panic-full”-diff-diff-diff-full-). In some other cases, the original periodicity may be implicitly shifted (e.g., full-diff-diff-diff-diff-full-“panic-full”-diff-diff-diff-diff-full . . . ). In other cases, the UE 115-a may continue reporting in the following instance as usual despite that condition being satisfied until the base station 105-a reconfigures the UE 115-a. This may be conditioned on that all differential references are associated with the latest PMI parameters 220 (e.g., full PMI). Alternatively, the UE 115-a may fallback to the PMI parameters 220 (e.g., full PMI) completely for the following reports as the CSI report with the condition being satisfied.

By implementing the different periodicities for PMI reporting, the UE 115-a may promote high reliability and low latency wireless communication. The UE 115-a may also manage resource utilization by supporting different periodicities for PMI reporting. Additionally, the UE 115-a may reduce power consumption by managing different periodicities for PMI reporting.

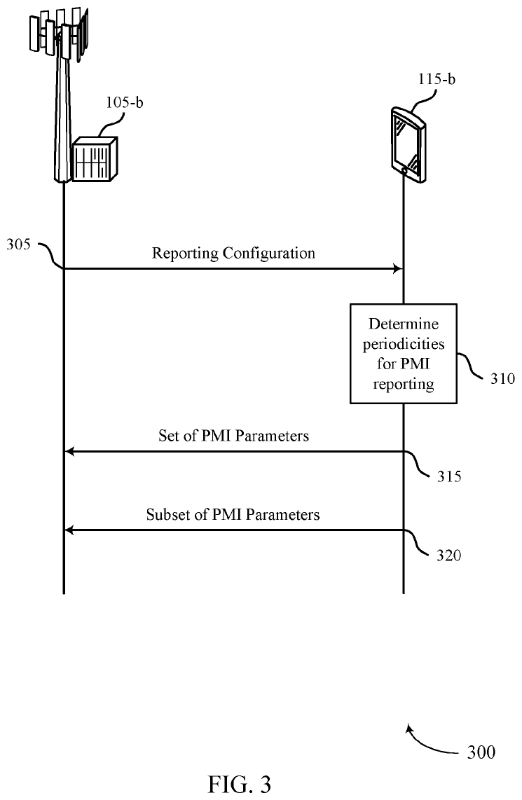

FIG. 3 illustrates an example of a process flow 300 that supports techniques for PMI reporting in accordance with aspects of the present disclosure. The process flow 300 may implement or be implemented by one or more aspects of the wireless communications system 100 or the wireless communications system 200. For example, the process flow 300 may correspond to communications between a base station 105-b and a UE 115-b, which may be examples of a base station 105 and a UE 115 as described with reference to FIGS. 1 and 2. In the following description of the process flow 300, operations between the base station 105-b and the UE 115-b may occur in a different order or at different times than as shown. Some operations may also be omitted from the process flow 300, and other operations may be added to the process flow 300.

At 305, the base station 105-a may transmit, and the UE 115-a may receive, a reporting configuration (e.g., a CSI reporting configuration). For example, base station 105-a may transmit, and the UE 115-a may receive, an RRC message carrying a reporting configuration for PMI reporting. At 310, the UE 115-a may determine periodicities for PMI reporting. For example, the reporting configuration may indicate periodicities for PMI reporting, and the UE 115-a may determine the periodicities for PMI reporting based on the reporting configuration.

At 315, the UE 115-a may transmit, and the base station 105-a may receive, a set of PMI parameters. For example, the UE 115-a may transmit, and the base station 105-a may receive, a set of PMI parameters according to a first periodicity. At 320, the UE 115-a may transmit, and the base station 105-a may receive, a subset of PMI parameters. For example, the UE 115-a may transmit, and the base station 105-a may receive, a subset of PMI parameters according to a second periodicity. The subset of PMI parameters may include one or more parameter of the set of PMI parameters. In some examples, the first periodicity may be greater than the second periodicity.

By implementing the different periodicities for PMI reporting, the base station 105-a and the UE 115-b may promote high reliability and low latency wireless communication.

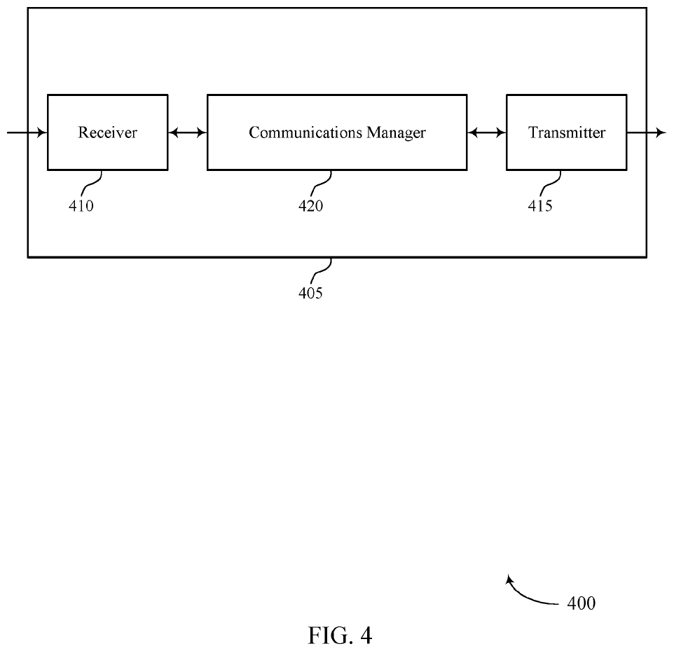

FIG. 4 shows a block diagram 400 of a device 405 that supports techniques for PMI reporting in accordance with aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for PMI reporting). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for PMI reporting). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of techniques for PMI reporting as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

The communications manager 420 may support wireless communication at the device 405 (e.g., a UE) in accordance with examples as disclosed herein. For example, the communications manager 420 may be configured as or otherwise support a means for receiving first control signaling indicating a reporting configuration for a set of multiple PMI parameters. The communications manager 420 may be configured as or otherwise support a means for transmitting second control signaling indicating a set of PMI parameters according to a first periodicity and based on the reporting configuration. The communications manager 420 may be configured as or otherwise support a means for transmitting third control signaling indicating a subset of PMI parameters of the set of PMI parameters according to a second periodicity and based on the reporting configuration.

By including or configuring the communications manager 420 in accordance with examples as described herein, the device 405 (e.g., a processor controlling or otherwise coupled to the receiver 410, the transmitter 415, the communications manager 420, or a combination thereof) may support techniques for reduced processing, reduced power consumption, and more efficient utilization of communication resources.

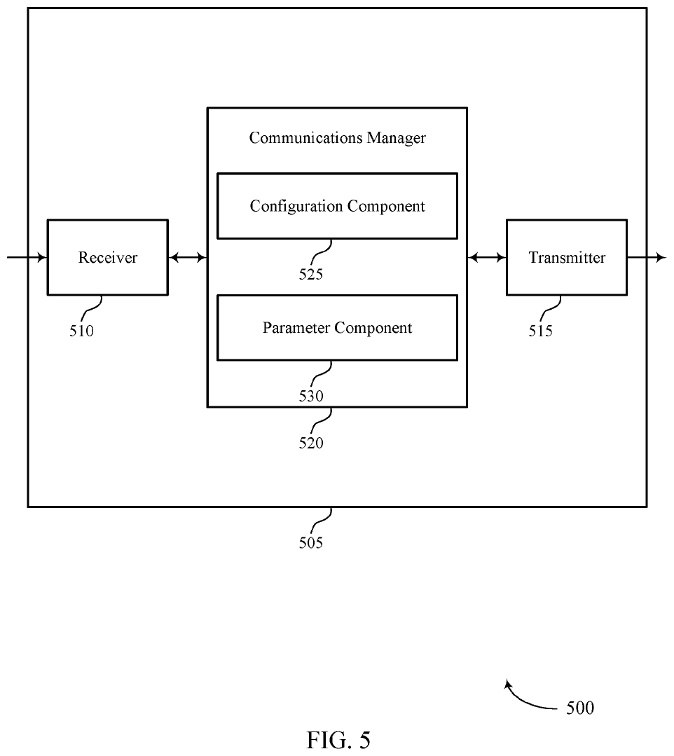

FIG. 5 shows a block diagram 500 of a device 505 that supports techniques for PMI reporting in accordance with aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for PMI reporting). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for PMI reporting). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for PMI reporting as described herein. For example, the communications manager 520 may include a configuration component 525 a parameter component 530, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at the device 505 (e.g., a UE) in accordance with examples as disclosed herein. The configuration component 525 may be configured as or otherwise support a means for receiving first control signaling indicating a reporting configuration for a set of multiple PMI parameters. The parameter component 530 may be configured as or otherwise support a means for transmitting second control signaling indicating a set of PMI parameters according to a first periodicity and based on the reporting configuration. The parameter component 530 may be configured as or otherwise support a means for transmitting third control signaling indicating a subset of PMI parameters of the set of PMI parameters according to a second periodicity and based on the reporting configuration.

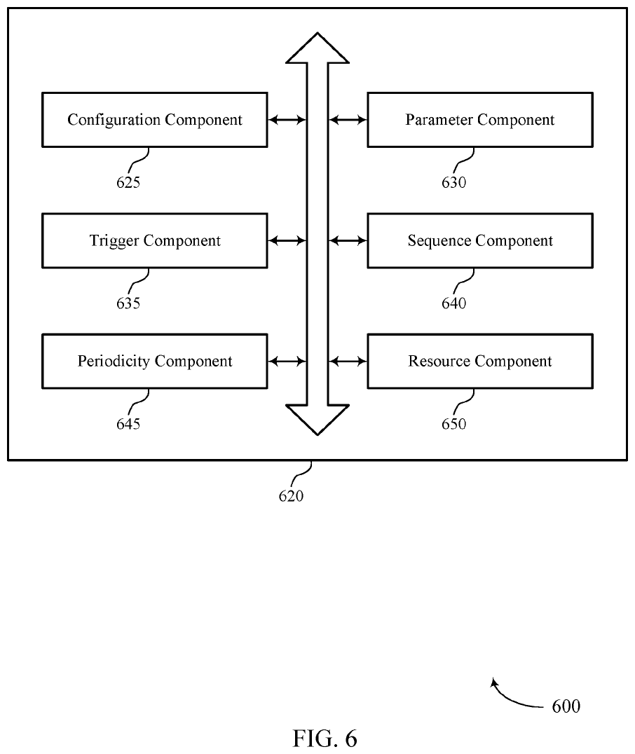

FIG. 6 shows a block diagram 600 of a communications manager 620 that supports techniques for PMI reporting in accordance with aspects of the present disclosure. The communications manager 620 may be an example of aspects of a communications manager 420, a communications manager 520, or both, as described herein. The communications manager 620, or various components thereof, may be an example of means for performing various aspects of techniques for PMI reporting as described herein. For example, the communications manager 620 may include a configuration component 625, a parameter component 630, a trigger component 635, a sequence component 640, a periodicity component 645, a resource component 650, or any combination thereof. Each of these components may communicate, directly or indirectly, with one another (e.g., via one or more buses).

The communications manager 620 may support wireless communication at a UE in accordance with examples as disclosed herein. The configuration component 625 may be configured as or otherwise support a means for receiving first control signaling indicating a reporting configuration for a set of multiple PMI parameters. The parameter component 630 may be configured as or otherwise support a means for transmitting second control signaling indicating a set of PMI parameters according to a first periodicity and based on the reporting configuration. In some examples, the parameter component 630 may be configured as or otherwise support a means for transmitting third control signaling indicating a subset of PMI parameters of the set of PMI parameters according to a second periodicity and based on the reporting configuration.

In some examples, to support receiving the first control signaling, the configuration component 625 may be configured as or otherwise support a means for receiving a single CSI reporting configuration for the set of multiple PMI parameters, the single CSI reporting configuration indicating one or both of the first periodicity or the second periodicity. In some examples, the configuration component 625 may be configured as or otherwise support a means for transmitting jointly the second control signaling and the third control signaling based on the single CSI reporting configuration, the second control signaling indicating a first CSI report and the third control signaling indicating a second CSI report, the first CSI report being adjacent to the second CSI report.

In some examples, the resource component 650 may be configured as or otherwise support a means for determining a resource allocation based on the single CSI reporting configuration, the resource allocation including a first set of resources for a first type of CSI report and a second set of resource for a second type of CSI report. In some examples, the parameter component 630 may be configured as or otherwise support a means for transmitting one or both of the second control signaling or the third control signaling based on the resource allocation.

In some examples, to support receiving the first control signaling, the configuration component 625 may be configured as or otherwise support a means for receiving a first CSI reporting configuration for the set of multiple PMI parameters. In some examples, to support receiving the first control signaling, the configuration component 625 may be configured as or otherwise support a means for receiving a second CSI reporting configuration for the subset of PMI parameters of the set of PMI parameters. In some examples, one or both of the first CSI reporting configuration or the second CSI reporting configuration indicate one or both of the first periodicity or the second periodicity.

In some examples, the resource component 650 may be configured as or otherwise support a means for determining a resource allocation based on the second CSI reporting configuration, the resource allocation including a first set of resources for a first type of CSI report and a second set of resource for a second type of CSI report. In some examples, the parameter component 630 may be configured as or otherwise support a means for transmitting one or both of the second control signaling or the third control signaling based on the resource allocation. In some examples, the set of PMI parameters includes one or both of a reference signal resource parameter or a reference signal port parameter. In some examples, the subset of PMI parameters of the set of PMI parameters includes a linear combination of NZ coefficients associated with the set of PMI parameters. In some examples, the subset of PMI parameters includes one or more of a channel quality indicator (CQI), a layer indicator (LI), a rank indicator (RI), a total number of NZ coefficients, a strongest coefficient indicator, a coefficient selection for different multiple-input multiple-output (MIMO) layers, or a quantized NZ coefficient.

In some examples, the trigger component 635 may be configured as or otherwise support a means for determining a condition to trigger reporting of one or both of the set of PMI parameters or the subset of PMI parameters. In some examples, the trigger component 635 may be configured as or otherwise support a means for transmitting, based on the condition, an indication for reporting one or both of the set of PMI parameters or the subset of PMI parameters. In some examples, the indication includes one or more bits in a first part of a CSI report. In some examples, transmitting the indication is based on the first control signaling. In some examples, transmitting the second control signaling indicating the set of PMI parameters of the set of multiple PMI parameters according to the first periodicity is further based on the condition.

In some examples, the parameter component 630 may be configured as or otherwise support a means for determining that the set of PMI parameters is less than the set of multiple PMI parameters. In some examples, the parameter component 630 may be configured as or otherwise support a means for transmitting the second control signaling further based on determining that the set of PMI parameters is less than the set of multiple PMI parameters.

In some examples, the sequence component 640 may be configured as or otherwise support a means for determining a sequence of PMI reporting based on a condition. In some examples, the parameter component 630 may be configured as or otherwise support a means for transmitting one or both of the second control signaling or the third control signaling further based on the sequence of PMI reporting. In some examples, one or both of the set of PMI parameters or the subset of PMI parameters are associated with the condition. In some examples, a priority associated with one or both of the second control signaling or the third control signaling is further based on the condition; or in some examples, the priority associated with one or both of the second control signaling or the third control signaling is further based on the condition and at least one PMI parameter of the set of multiple PMI parameters satisfying a threshold.

In some examples, the periodicity component 645 may be configured as or otherwise support a means for determining one or both of the first periodicity or the second periodicity based on a codebook. In some examples, the parameter component 630 may be configured as or otherwise support a means for transmitting one or both of the second control signaling or the third control signaling further based on the codebook.

In some examples, the resource component 650 may be configured as or otherwise support a means for determining a first set of central processing unit resources associated with the set of PMI parameters of the set of multiple PMI parameters and a second set of central processing unit resources associated with the subset of PMI parameters of the set of PMI parameters, the second set of central processing unit (CPU) resources is less than the first set of CPU resources. In some examples, the parameter component 630 may be configured as or otherwise support a means for transmitting one or both of the second control signaling or the third control signaling based on the first set of CPU resources and the second set of CPU resources.

In some examples, the parameter component 630 may be configured as or otherwise support a means for determining a differential between the set of PMI parameters and the subset of PMI parameters. In some examples, the parameter component 630 may be configured as or otherwise support a means for transmitting one or both of the second control signaling or the third control signaling based on the differential. In some examples, one or both of the second control signaling or the third control signaling includes one or both of non-differential coefficients or differential coefficients combinations of the set of multiple PMI parameters.

In some examples, the parameter component 630 may be configured as or otherwise support a means for determining that the differential coefficients includes one or both of a differential amplitude quantization or a differential phase quantization. In some examples, the parameter component 630 may be configured as or otherwise support a means for transmitting one or both of the second control signaling or the third control signaling based on determining that the differential coefficients includes one or both of the differential amplitude quantization or the differential phase quantization.

In some examples, the parameter component 630 may be configured as or otherwise support a means for determining that the differential coefficients includes one or both of a number of bits quantizing a differential amplitude change or a number of bits quantizing a differential phase change. In some examples, the parameter component 630 may be configured as or otherwise support a means for transmitting one or both of the second control signaling or the third control signaling based on determining that the differential coefficients includes one or both of the number of bits quantizing the differential amplitude change or the number of bits quantizing the differential phase change. In some examples, the second control signaling includes less bits for quantization than the third control signaling.

In some examples, the periodicity component 645 may be configured as or otherwise support a means for determining a shift to a periodicity for PMI reporting. In some examples, the parameter component 630 may be configured as or otherwise support a means for transmitting one or both of the second control signaling or the third control signaling further based on the shift to the periodicity for PMI reporting. In some examples, the first periodicity being greater than the second periodicity. In some examples, the first periodicity and the second periodicity correspond to an offset in a time domain between the first periodicity and the second periodicity.

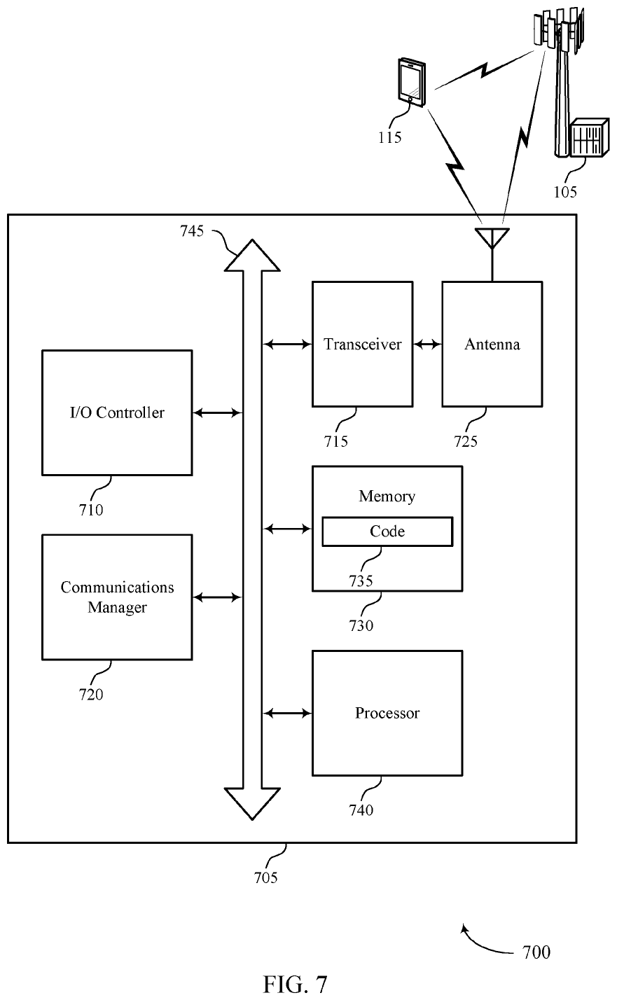

FIG. 7 shows a diagram of a system 700 including a device 705 that supports techniques for PMI reporting in accordance with aspects of the present disclosure. The device 705 may be an example of or include the components of a device 405, a device 505, or a UE 115 as described herein. The device 705 may communicate wirelessly with one or more base stations 105, UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting techniques for PMI reporting). For example, the device 705 or a component of the device 705 may include a processor 740 and memory 730 coupled to the processor 740, the processor 740 and memory 730 configured to perform various functions described herein.

The communications manager 720 may support wireless communication at the device 705 (e.g., a UE) in accordance with examples as disclosed herein. For example, the communications manager 720 may be configured as or otherwise support a means for receiving first control signaling indicating a reporting configuration for a set of multiple PMI parameters. The communications manager 720 may be configured as or otherwise support a means for transmitting second control signaling indicating a set of PMI parameters according to a first periodicity and based on the reporting configuration. The communications manager 720 may be configured as or otherwise support a means for transmitting third control signaling indicating a subset of PMI parameters of the set of PMI parameters according to a second periodicity and based on the reporting configuration. By including or configuring the communications manager 720 in accordance with examples as described herein, the device 705 may support techniques for reduced power consumption.

In some examples, the communications manager 720 may be configured to perform various operations (e.g., receiving, monitoring, transmitting) using or otherwise in cooperation with the transceiver 715, the one or more antennas 725, or any combination thereof. For example, the communications manager 720 may be configured to receive or transmit messages or other signaling as described herein via the transceiver 715. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of techniques for PMI reporting as described herein, or the processor 740 and the memory 730 may be otherwise configured to perform or support such operations.

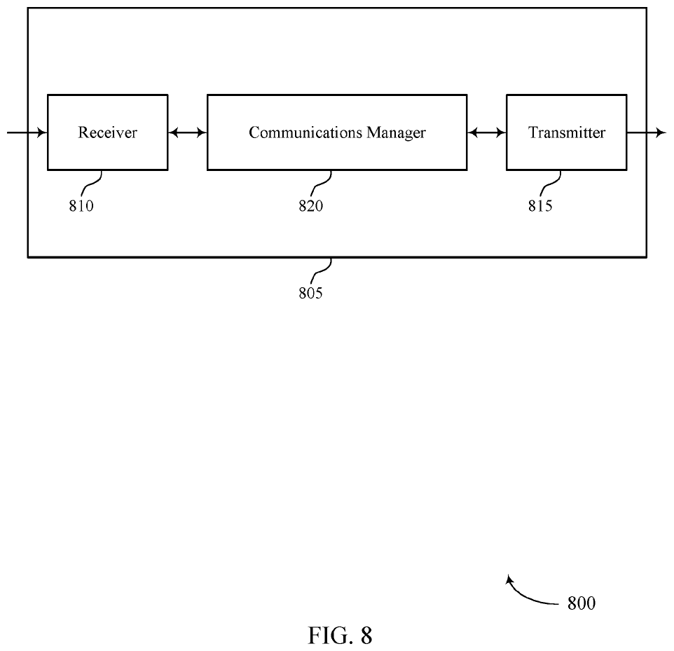

FIG. 8 shows a block diagram 800 of a device 805 that supports techniques for PMI reporting in accordance with aspects of the present disclosure. The device 805 may be an example of aspects of a base station 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for PMI reporting). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for PMI reporting). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for PMI reporting as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at the device 805 (e.g., a base station) in accordance with examples as disclosed herein. For example, the communications manager 820 may be configured as or otherwise support a means for transmitting first control signaling indicating a reporting configuration for a set of multiple PMI parameters. The communications manager 820 may be configured as or otherwise support a means for receiving second control signaling indicating a set of PMI parameters according to a first periodicity and based on the reporting configuration. The communications manager 820 may be configured as or otherwise support a means for receiving third control signaling indicating a subset of PMI parameters of the set of PMI parameters according to a second periodicity and based on the reporting configuration.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for reduced power consumption.

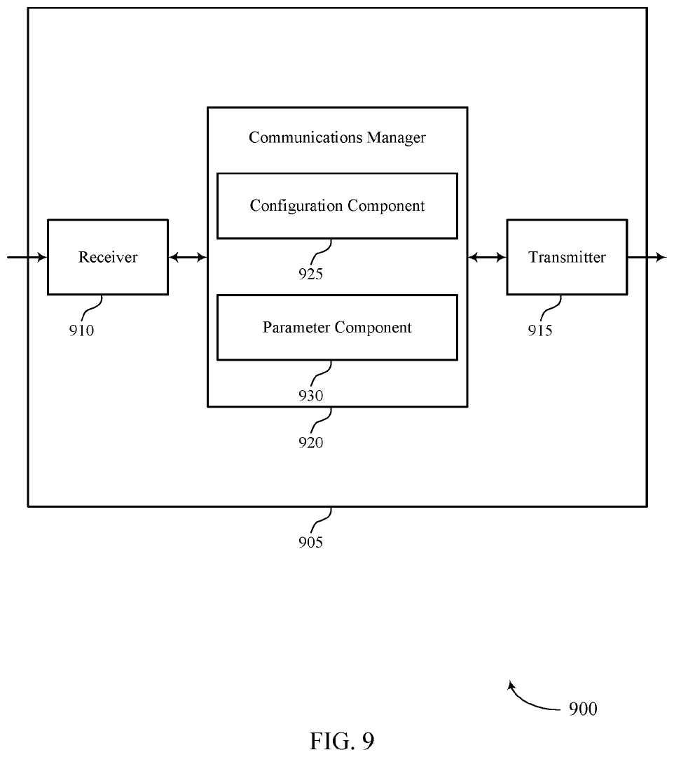

FIG. 9 shows a block diagram 900 of a device 905 that supports techniques for PMI reporting in accordance with aspects of the present disclosure. The device 905 may be an example of aspects of a device 805 or a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for PMI reporting). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for PMI reporting). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for PMI reporting as described herein. For example, the communications manager 920 may include a configuration component 925 a parameter component 930, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at the device 905 (e.g., a base station) in accordance with examples as disclosed herein. The configuration component 925 may be configured as or otherwise support a means for transmitting first control signaling indicating a reporting configuration for a set of multiple PMI parameters. The parameter component 930 may be configured as or otherwise support a means for receiving second control signaling indicating a set of PMI parameters according to a first periodicity and based on the reporting configuration. The parameter component 930 may be configured as or otherwise support a means for receiving third control signaling indicating a subset of PMI parameters of the set of PMI parameters according to a second periodicity and based on the reporting configuration.

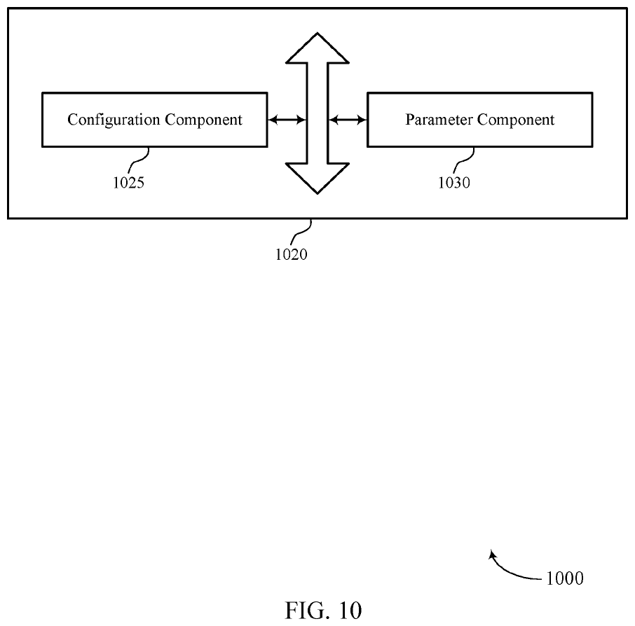

FIG. 10 shows a block diagram 1000 of a communications manager 1020 that supports techniques for PMI reporting in accordance with aspects of the present disclosure. The communications manager 1020 may be an example of aspects of a communications manager 820, a communications manager 920, or both, as described herein. The communications manager 1020, or various components thereof, may be an example of means for performing various aspects of techniques for PMI reporting as described herein. For example, the communications manager 1020 may include a configuration component 1025 a parameter component 1030, or any combination thereof. Each of these components may communicate, directly or indirectly, with one another (e.g., via one or more buses).

The communications manager 1020 may support wireless communication at a base station in accordance with examples as disclosed herein. The configuration component 1025 may be configured as or otherwise support a means for transmitting first control signaling indicating a reporting configuration for a set of multiple PMI parameters. The parameter component 1030 may be configured as or otherwise support a means for receiving second control signaling indicating a set of PMI parameters according to a first periodicity and based on the reporting configuration. In some examples, the parameter component 1030 may be configured as or otherwise support a means for receiving third control signaling indicating a subset of PMI parameters of the set of PMI parameters according to a second periodicity and based on the reporting configuration. In some examples, the set of PMI parameters includes one or both of a reference signal resource parameter or a reference signal port parameter. In some examples, the subset of PMI parameters of the set of PMI parameters includes a linear combination of NZ coefficients associated with the set of PMI parameters.

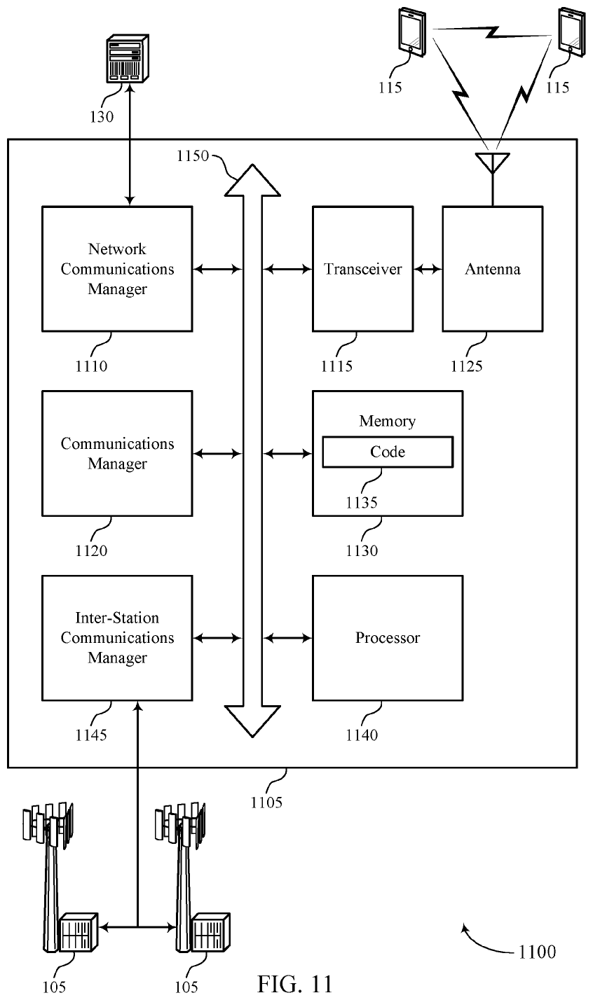

FIG. 11 shows a diagram of a system 1100 including a device 1105 that supports techniques for PMI reporting in accordance with aspects of the present disclosure. The device 1105 may be an example of or include the components of a device 805, a device 905, or a base station 105 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, a network communications manager 1110, a transceiver 1115, an antenna 1125, a memory 1130, code 1135, a processor 1140, and an inter-station communications manager 1145. These components may be in electronic communication or otherwise coupled (e.g., operatively, communicatively, functionally, electronically, electrically) via one or more buses (e.g., a bus 1150).

The network communications manager 1110 may manage communications with a core network 130 (e.g., via one or more wired backhaul links). For example, the network communications manager 1110 may manage the transfer of data communications for client devices, such as one or more UEs 115.

In some cases, the device 1105 may include a single antenna 1125. However, in some other cases the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include RAM and ROM. The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a BIOS which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for PMI reporting). For example, the device 1105 or a component of the device 1105 may include a processor 1140 and memory 1130 coupled to the processor 1140, the processor 1140 and memory 1130 configured to perform various functions described herein.

The inter-station communications manager 1145 may manage communications with other base stations 105, and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communications network technology to provide communication between base stations 105.

The communications manager 1120 may support wireless communication at the device 1105 (e.g., a base station) in accordance with examples as disclosed herein. For example, the communications manager 1120 may be configured as or otherwise support a means for transmitting first control signaling indicating a reporting configuration for a set of multiple PMI parameters. The communications manager 1120 may be configured as or otherwise support a means for receiving second control signaling indicating a set of PMI parameters according to a first periodicity and based on the reporting configuration. The communications manager 1120 may be configured as or otherwise support a means for receiving third control signaling indicating a subset of PMI parameters of the set of PMI parameters according to a second periodicity and based on the reporting configuration. By including or configuring the communications manager 1120 in accordance with examples as described herein, the device 1105 may support techniques for more efficient utilization of communication resource, longer battery life, and improved utilization of processing capability.

In some examples, the communications manager 1120 may be configured to perform various operations (e.g., receiving, monitoring, transmitting) using or otherwise in cooperation with the transceiver 1115, the one or more antennas 1125, or any combination thereof. For example, the communications manager 1120 may be configured to receive or transmit messages or other signaling as described herein via the transceiver 1115. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for PMI reporting as described herein, or the processor 1140 and the memory 1130 may be otherwise configured to perform or support such operations.

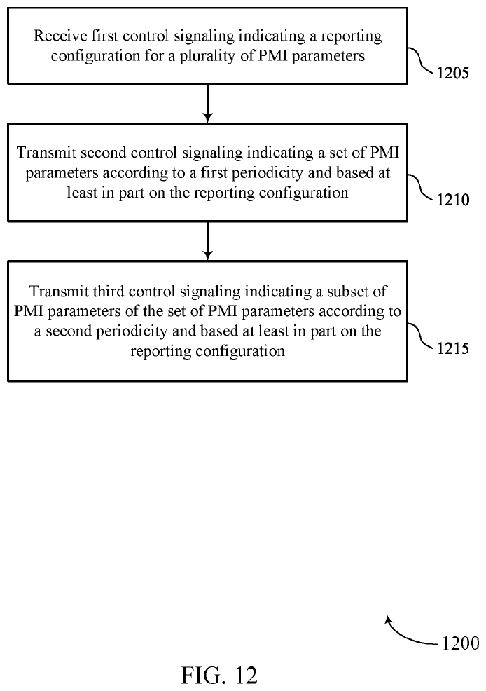

FIG. 12 shows a flowchart illustrating a method 1200 that supports techniques for PMI reporting in accordance with aspects of the present disclosure. The operations of the method 1200 may be implemented by a UE or its components as described herein. For example, the operations of the method 1200 may be performed by a UE as described with reference to FIGS. 1 through 7. In some examples, a UE may execute a set of instructions to control the functional elements of the UE to perform the described functions. Additionally or alternatively, A UE may perform aspects of the described functions using special-purpose hardware.

At 1205, the method may include receiving first control signaling indicating a reporting configuration for a set of multiple PMI parameters. The operations of 1205 may be performed in accordance with examples as disclosed herein. In some examples, aspects of the operations of 1205 may be performed by a configuration component 625 as described with reference to FIG. 6. Additionally or alternatively, means for performing 1205 may, but not necessarily, include, for example, antenna 725, transceiver 715, communications manager 720, memory 730 (including code 735), processor 740 and/or bus 750.

At 1210, the method may include transmitting second control signaling indicating a set of PMI parameters according to a first periodicity and based on the reporting configuration. The operations of 1210 may be performed in accordance with examples as disclosed herein. In some examples, aspects of the operations of 1210 may be performed by a parameter component 630 as described with reference to FIG. 6. Additionally or alternatively, means for performing 1210 may, but not necessarily, include, for example, antenna 725, transceiver 715, communications manager 720, memory 730 (including code 735), processor 740 and/or bus 750.

At 1215, the method may include transmitting third control signaling indicating a subset of PMI parameters of the set of PMI parameters according to a second periodicity and based on the reporting configuration. The operations of 1215 may be performed in accordance with examples as disclosed herein. In some examples, aspects of the operations of 1215 may be performed by parameter component 630 as described with reference to FIG. 6. Additionally or alternatively, means for performing 1215 may, but not necessarily, include, for example, antenna 725, transceiver 715, communications manager 720, memory 730 (including code 735), processor 740 and/or bus 750.

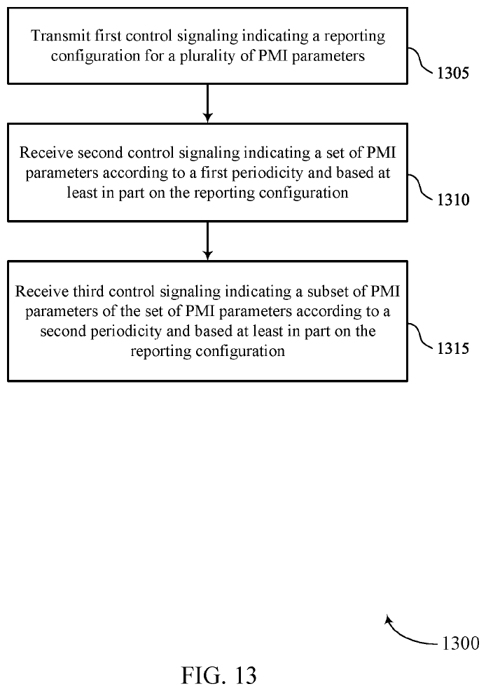

FIG. 13 shows a flowchart illustrating a method 1300 that supports techniques for PMI reporting in accordance with aspects of the present disclosure. The operations of the method 1300 may be implemented by a base station or its components as described herein. For example, the operations of the method 1300 may be performed by a base station as described with reference to FIGS. 8 through 11. In some examples, a base station may execute a set of instructions to control the functional elements of the base station to perform the described functions. Additionally or alternatively, a base station may perform aspects of the described functions using special-purpose hardware.

At 1305, the method may include transmitting first control signaling indicating a reporting configuration for a set of multiple PMI parameters. The operations of 1305 may be performed in accordance with examples as disclosed herein. In some examples, aspects of the operations of 1305 may be performed by a configuration component 1025 as described with reference to FIG. 10. Additionally or alternatively, means for performing 1305 may, but not necessarily, include, for example, antenna 1125, transceiver 1115, communications manager 1120, memory 1130 (including code 1135), processor 1140 and/or bus 1150.

At 1310, the method may include receiving second control signaling indicating a set of PMI parameters according to a first periodicity and based on the reporting configuration. The operations of 1310 may be performed in accordance with examples as disclosed herein. In some examples, aspects of the operations of 1310 may be performed by a parameter component 1030 as described with reference to FIG. 10. Additionally or alternatively, means for performing 1310 may, but not necessarily, include, for example, antenna 1125, transceiver 1115, communications manager 1120, memory 1130 (including code 1135), processor 1140 and/or bus 1150.

At 1315, the method may include receiving third control signaling indicating a subset of PMI parameters of the set of PMI parameters according to a second periodicity and based on the reporting configuration. The operations of 1315 may be performed in accordance with examples as disclosed herein. In some examples, aspects of the operations of 1315 may be performed by a parameter component 1030 as described with reference to FIG. 10. Additionally or alternatively, means for performing 1315 may, but not necessarily, include, for example, antenna 1125, transceiver 1115, communications manager 1120, memory 1130 (including code 1135), processor 1140 and/or bus 1150.

The following provides an overview of aspects of the present disclosure:

Aspect 1: A method for wireless communication at a UE, comprising: receiving first control signaling indicating a reporting configuration for a plurality of PMI parameters; transmitting second control signaling indicating a set of PMI parameters according to a first periodicity and based at least in part on the reporting configuration; and transmitting third control signaling indicating a subset of PMI parameters of the set of PMI parameters according to a second periodicity and based at least in part on the reporting configuration.

Aspect 2: The method of aspect 1, wherein receiving the first control signaling comprises: receiving a single CSI reporting configuration for the plurality of PMI parameters, the single CSI reporting configuration indicating one or both of the first periodicity or the second periodicity.

Aspect 3: The method of aspect 2, further comprising: transmitting jointly the second control signaling and the third control signaling based at least in part on the single CSI reporting configuration, the second control signaling indicating a first CSI report and the third control signaling indicating a second CSI report, the first CSI report being adjacent to the second CSI report.

Aspect 4: The method of any of aspects 2 through 3, further comprising: determining a resource allocation based at least in part on the single CSI reporting configuration, the resource allocation comprising a first set of resources for a first type of CSI report and a second set of resource for a second type of CSI report, wherein transmitting one or both of the second control signaling or the third control signaling is based at least in part on the resource allocation.

Aspect 5: The method of any of aspects 1 through 4, wherein receiving the first control signaling comprises: receiving a first CSI reporting configuration for the plurality of PMI parameters; and receiving a second CSI reporting configuration for the subset of PMI parameters of the set of PMI parameters, wherein one or both of the first CSI reporting configuration or the second CSI reporting configuration indicate one or both of the first periodicity or the second periodicity.

Aspect 6: The method of aspect 5, further comprising: determining a resource allocation based at least in part on the second CSI reporting configuration, the resource allocation comprising a first set of resources for a first type of CSI report and a second set of resource for a second type of CSI report, wherein transmitting one or both of the second control signaling or the third control signaling is based at least in part on the resource allocation.

Aspect 7: The method of any of aspects 1 through 6, wherein the set of PMI parameters comprises one or both of a reference signal resource parameter or a reference signal port parameter; and the subset of PMI parameters of the set of PMI parameters comprises a linear combination of NZ coefficients associated with the set of PMI parameters.

Aspect 8: The method of any of aspects 1 through 7, wherein the subset of PMI parameters comprises one or more of a channel quality indicator, a layer indicator, a rank indicator, a total number of NZ coefficients, a strongest coefficient indicator, a coefficient selection for different multiple-input multiple-output layers, or a quantized NZ coefficient.

Aspect 9: The method of any of aspects 1 through 8, further comprising: determining a condition to trigger reporting of one or both of the set of PMI parameters or the subset of PMI parameters; and transmitting, based at least in part on the condition, an indication for reporting one or both of the set of PMI parameters or the subset of PMI parameters.

Aspect 10: The method of aspect 9, wherein the indication comprises one or more bits in a first part of a CSI report.

Aspect 11: The method of any of aspects 9 through 10, wherein transmitting the indication is based at least in part on the first control signaling.

Aspect 12: The method of any of aspects 9 through 11, wherein transmitting the second control signaling indicating the set of PMI parameters of the plurality of PMI parameters according to the first periodicity is further based at least in part on the condition.

Aspect 13: The method of any of aspects 9 through 12, further comprising: determining that the set of PMI parameters is less than the plurality of PMI parameters, wherein transmitting the second control signaling is further based at least in part on determining that the set of PMI parameters is less than the plurality of PMI parameters.

Aspect 14: The method of any of aspects 1 through 13, further comprising: determining a sequence of PMI reporting based at least in part on a condition, wherein transmitting one or both of the second control signaling or the third control signaling is further based at least in part on the sequence of PMI reporting.

Aspect 15: The method of aspect 14, wherein one or both of the set of PMI parameters or the subset of PMI parameters are associated with the condition.

Aspect 16: The method of any of aspects 14 through 15, wherein a priority associated with one or both of the second control signaling or the third control signaling is further based at least in part on the condition; or the priority associated with one or both of the second control signaling or the third control signaling is further based at least in part on the condition and at least one PMI parameter of the plurality of PMI parameters satisfying a threshold.

Aspect 17: The method of any of aspects 1 through 16, further comprising: determining one or both of the first periodicity or the second periodicity based at least in part on a codebook, wherein transmitting one or both of the second control signaling or the third control signaling is further based at least in part on the codebook.

Aspect 18: The method of any of aspects 1 through 17, further comprising: determining a first set of central processing unit (CPU) resources associated with the set of PMI parameters of the plurality of PMI parameters and a second set of CPU resources associated with the subset of PMI parameters of the set of PMI parameters, the second set of CPU resources is less than the first set of CPU resources, wherein transmitting one or both of the second control signaling or the third control signaling is further based at least in part on the first set of CPU resources and the second set of CPU resources.

Aspect 19: The method of any of aspects 1 through 18, further comprising: determining a differential between the set of PMI parameters and the subset of PMI parameters, wherein transmitting one or both of the second control signaling or the third control signaling is further based at least in part on the differential, and wherein the second control signaling comprises less bits for quantization than the third control signaling.

Aspect 20: The method of aspect 19, wherein one or both of the second control signaling or the third control signaling comprises one or both of non-differential coefficients or differential coefficients combinations of the plurality of PMI parameters.

Aspect 21: The method of aspect 20, further comprising: determining that the differential coefficients comprises one or both of a differential amplitude quantization or a differential phase quantization, wherein transmitting one or both of the second control signaling or the third control signaling is further based at least in part on determining that the differential coefficients comprises one or both of the differential amplitude quantization or the differential phase quantization; or determining that the differential coefficients comprises one or both of a number of bits quantizing a differential amplitude change or a number of bits quantizing a differential phase change, wherein transmitting one or both of the second control signaling or the third control signaling is further based at least in part on determining that the differential coefficients comprises one or both of the number of bits quantizing the differential amplitude change or the number of bits quantizing the differential phase change.

Aspect 22: The method of any of aspects 19 through 21, further comprising: determining a shift to a periodicity for PMI reporting, wherein transmitting one or both of the second control signaling or the third control signaling is further based at least in part on the shift to the periodicity for PMI reporting.

Aspect 23: The method of any of aspects 1 through 22, wherein the first periodicity being greater than the second periodicity, and the first periodicity and the second periodicity correspond to an offset in a time domain between the first periodicity and the second periodicity.

Aspect 24: A method for wireless communication at a base station, comprising: transmitting first control signaling indicating a reporting configuration for a plurality of PMI parameters; receiving second control signaling indicating a set of PMI parameters according to a first periodicity and based at least in part on the reporting configuration; and receiving third control signaling indicating a subset of PMI parameters of the set of PMI parameters according to a second periodicity and based at least in part on the reporting configuration.

Aspect 25: The method of aspect 24, wherein the set of PMI parameters comprises one or both of a reference signal resource parameter or a reference signal port parameter; and the subset of PMI parameters of the set of PMI parameters comprises a linear combination of NZ coefficients associated with the set of PMI parameters.

Aspect 26: An apparatus for wireless communication, comprising a processor; memory; a transceiver; and at least one processor of a UE, the at least one processor coupled with the memory and the transceiver, and the at least one processor configured to cause the apparatus to perform a method of any of aspects 1 through 23.

Aspect 27: An apparatus for wireless communication, comprising at least one means for performing a method of any of aspects 1 through 23.

Aspect 28: A non-transitory computer-readable medium storing code for wireless communication at a UE, the code comprising instructions executable by a processor to perform a method of any of aspects 1 through 23.

Aspect 29: An apparatus for wireless communication at a base station, comprising a processor; a transceiver; and at least one processor of a base station, the at least one processor coupled with the memory and the transceiver, and the at least one processor configured to cause the apparatus to perform a method of any of aspects 24through 25.

Aspect 30: An apparatus for wireless communication at a base station, comprising at least one means for performing a method of any of aspects 24 through 25.

Aspect 31: A non-transitory computer-readable medium storing code for wireless communication at a base station, the code comprising instructions executable by a processor to perform a method of any of aspects 24 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving first control signaling indicating a reporting configuration for a plurality of precoding matrix indicator parameters;
transmitting second control signaling indicating a set of precoding matrix indicator parameters according to a first periodicity and based at least in part on the reporting configuration; and
transmitting third control signaling indicating a subset of precoding matrix indicator parameters of the set of precoding matrix indicator parameters according to a second periodicity and based at least in part on the reporting configuration.

2. The method of claim 1, wherein receiving the first control signaling comprises:
receiving a single channel state information reporting configuration for the plurality of precoding matrix indicator parameters, the single channel state information reporting configuration indicating one or both of the first periodicity or the second periodicity.

3. The method of claim 2, further comprising:
transmitting jointly the second control signaling and the third control signaling based at least in part on the single channel state information reporting configuration, the second control signaling indicating a first channel state information report and the third control signaling indicating a second channel state information report, the first channel state information report being adjacent to the second channel state information report.

4. The method of claim 2, further comprising:
determining a resource allocation based at least in part on the single channel state information reporting configuration, the resource allocation comprising a first set of resources for a first type of channel state information report and a second set of resource for a second type of channel state information report,
wherein transmitting one or both of the second control signaling or the third control signaling is based at least in part on the resource allocation.

5. The method of claim 1, wherein receiving the first control signaling comprises:
receiving a first channel state information reporting configuration for the plurality of precoding matrix indicator parameters; and
receiving a second channel state information reporting configuration for the subset of precoding matrix indicator parameters of the set of precoding matrix indicator parameters,
wherein one or both of the first channel state information reporting configuration or the second channel state information reporting configuration indicate one or both of the first periodicity or the second periodicity.

6. The method of claim 5, further comprising:
determining a resource allocation based at least in part on the second channel state information reporting configuration, the resource allocation comprising a first set of resources for a first type of channel state information report and a second set of resource for a second type of channel state information report,
wherein transmitting one or both of the second control signaling or the third control signaling is based at least in part on the resource allocation.

7. The method of claim 1, wherein:
the set of precoding matrix indicator parameters comprises one or both of a reference signal resource parameter or a reference signal port parameter; and
the subset of precoding matrix indicator parameters of the set of precoding matrix indicator parameters comprises a linear combination of non-zero coefficients associated with the set of precoding matrix indicator parameters.

8. The method of claim 1, wherein the subset of precoding matrix indicator parameters comprises one or more of a channel quality indicator, a layer indicator, a rank indicator, a total number of non-zero coefficients, a strongest coefficient indicator, a coefficient selection for different multiple-input multiple-output layers, or a quantized non-zero coefficient.

9. The method of claim 1, further comprising:
determining a condition to trigger reporting of one or both of the set of precoding matrix indicator parameters or the subset of precoding matrix indicator parameters; and
transmitting, based at least in part on the condition, an indication for reporting one or both of the set of precoding matrix indicator parameters or the subset of precoding matrix indicator parameters.

10. The method of claim 9, wherein the indication comprises one or more bits in a first part of a channel state information report.

11. The method of claim 9, wherein transmitting the indication is based at least in part on the first control signaling.

12. The method of claim 9, wherein transmitting the second control signaling indicating the set of precoding matrix indicator parameters of the plurality of precoding matrix indicator parameters according to the first periodicity is further based at least in part on the condition.

13. The method of claim 9, further comprising:
determining that the set of precoding matrix indicator parameters is less than the plurality of precoding matrix indicator parameters,
wherein transmitting the second control signaling is further based at least in part on determining that the set of precoding matrix indicator parameters is less than the plurality of precoding matrix indicator parameters.

14. The method of claim 1, further comprising:
determining a sequence of precoding matrix indicator reporting based at least in part on a condition,
wherein transmitting one or both of the second control signaling or the third control signaling is further based at least in part on the sequence of precoding matrix indicator reporting.

15. The method of claim 14, wherein one or both of the set of precoding matrix indicator parameters or the subset of precoding matrix indicator parameters are associated with the condition.

16. The method of claim 14, wherein a priority associated with one or both of the second control signaling or the third control signaling is further based at least in part on the condition, or the priority associated with one or both of the second control signaling or the third control signaling is further based at least in part on the condition and at least one precoding matrix indicator parameter of the plurality of precoding matrix indicator parameters satisfying a threshold.

17. The method of claim 1, further comprising:
determining one or both of the first periodicity or the second periodicity based at least in part on a codebook,
wherein transmitting one or both of the second control signaling or the third control signaling is further based at least in part on the codebook.

18. The method of claim 1, further comprising:
determining a first set of central processing unit resources associated with the set of precoding matrix indicator parameters of the plurality of precoding matrix indicator parameters and a second set of central processing unit resources associated with the subset of precoding matrix indicator parameters of the set of precoding matrix indicator parameters, the second set of central processing unit resources is less than the first set of central processing unit resources,
wherein transmitting one or both of the second control signaling or the third control signaling is further based at least in part on the first set of central processing unit resources and the second set of central processing unit resources.

19. The method of claim 1, further comprising:
determining a differential between the set of precoding matrix indicator parameters and the subset of precoding matrix indicator parameters,
wherein transmitting one or both of the second control signaling or the third control signaling is further based at least in part on the differential, and wherein the second control signaling comprises less bits for quantization than the third control signaling.

20. The method of claim 19, wherein one or both of the second control signaling or the third control signaling comprises one or both of non-differential coefficients or differential coefficients combinations of the plurality of precoding matrix indicator parameters.

21. The method of claim 20, further comprising:
determining that the differential coefficients comprises one or both of a differential amplitude quantization or a differential phase quantization, wherein transmitting one or both of the second control signaling or the third control signaling is further based at least in part on determining that the differential coefficients comprises one or both of the differential amplitude quantization or the differential phase quantization; or
determining that the differential coefficients comprises one or both of a number of bits quantizing a differential amplitude change or a number of bits quantizing a differential phase change, wherein transmitting one or both of the second control signaling or the third control signaling is further based at least in part on determining that the differential coefficients comprises one or both of the number of bits quantizing the differential amplitude change or the number of bits quantizing the differential phase change.

22. The method of claim 19, further comprising:
determining a shift to a periodicity for precoding matrix indicator reporting,
wherein transmitting one or both of the second control signaling or the third control signaling is further based at least in part on the shift to the periodicity for precoding matrix indicator reporting.

23. The method of claim 1, wherein:
the first periodicity being greater than the second periodicity, and
the first periodicity and the second periodicity correspond to an offset in a time domain between the first periodicity and the second periodicity.

24. A method for wireless communication at a base station, comprising:
transmitting first control signaling indicating a reporting configuration for a plurality of precoding matrix indicator parameters;
receiving second control signaling indicating a set of precoding matrix indicator parameters according to a first periodicity and based at least in part on the reporting configuration; and
receiving third control signaling indicating a subset of precoding matrix indicator parameters of the set of precoding matrix indicator parameters according to a second periodicity and based at least in part on the reporting configuration.

25. The method of claim 24, wherein:
the set of precoding matrix indicator parameters comprises one or both of a reference signal resource parameter or a reference signal port parameter; and
the subset of precoding matrix indicator parameters of the set of precoding matrix indicator parameters comprises a linear combination of non-zero coefficients associated with the set of precoding matrix indicator parameters.

26. An apparatus for wireless communication, comprising:
memory;
a transceiver; and
at least one processor of a user equipment (UE), the at least one processor coupled with the memory and the transceiver, and the at least one processor configured to cause the apparatus to:
receive first control signaling indicating a reporting configuration for a plurality of precoding matrix indicator parameters;
transmit second control signaling indicating a set of precoding matrix indicator parameters according to a first periodicity and based at least in part on the reporting configuration; and
transmit third control signaling indicating a subset of precoding matrix indicator parameters of the set of precoding matrix indicator parameters according to a second periodicity and based at least in part on the reporting configuration.

27. The apparatus of claim 26, the at least one processor further configured to cause the apparatus to:
determine a condition to trigger reporting of one or both of the set of precoding matrix indicator parameters or the subset of precoding matrix indicator parameters; and
transmit, based at least in part on the condition, an indication for reporting one or both of the set of precoding matrix indicator parameters or the subset of precoding matrix indicator parameters.

28. The apparatus of claim 26, the at least one processor further configured to cause the apparatus to:
determine a sequence of precoding matrix indicator reporting based at least in part on a condition,
wherein the at least one processor further configured to cause the apparatus to transmit one or both of the second control signaling or the third control signaling is further based at least in part on the sequence of precoding matrix indicator reporting.

29. The apparatus of claim 26, the at least one processor further configured to cause the apparatus to:
determine that the differential coefficients comprises one or both of a differential amplitude quantization or a differential phase quantization, wherein the at least one processor further configured to cause the apparatus to transmit one or both of the second control signaling or the third control signaling is further based at least in part on determining that the differential coefficients comprises one or both of the differential amplitude quantization or the differential phase quantization; or
determine that the differential coefficients comprises one or both of a number of bits quantizing a differential amplitude change or a number of bits quantizing a differential phase change, wherein the at least one processor further configured to cause the apparatus to transmit one or both of the second control signaling or the third control signaling is further based at least in part on determining that the differential coefficients comprises one or both of the number of bits quantizing the differential amplitude change or the number of bits quantizing the differential phase change.

30. An apparatus for wireless communication, comprising:
memory;
a transceiver; and
at least one processor of a base station, the at least one processor coupled with the memory and the transceiver, and the at least one processor configured to cause the apparatus to:
transmit first control signaling indicating a reporting configuration for a plurality of precoding matrix indicator parameters;
receive second control signaling indicating a set of precoding matrix indicator parameters according to a first periodicity and based at least in part on the reporting configuration; and
receive third control signaling indicating a subset of precoding matrix indicator parameters of the set of precoding matrix indicator parameters according to a second periodicity and based at least in part on the reporting configuration.
